(19) United States
(12) Patent Application Publication
(10) Pub. No.: US 2009/0327725 A1
(43) Pub. Date: Dec. 31, 2009

(54) Content object management method, right object providing method, content object revocation method based thereon, and device using the same

(75) Inventor: Jung-Hun Park, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/459,126

(22) Filed: Jun. 26, 2009

(30) Foreign Application Priority Data
Jun. 26, 2008 (KR) 10-2008-0060942

(51) Int. Cl. H04L 9/32; G06F 21/00; G06Q 10/00; G06Q 50/00

(52) U.S. Cl. 713/169; 726/27; 705/34; 713/168

(57) ABSTRACT

A device for managing a rights object and revoking a content object. The device includes a content/rights object storage unit for storing at least one content object, and a rights object corresponding to each content object. An authentication module performs mutual authentication between devices giving and taking a rights object, and when a revocation notification of a rights object among the stored rights object is received, authenticates whether an author having transferred the revocation notification is an author having a revocation right. A content object checking unit checks if the content object is valid before the content object is executed. A rights object management module searches for a rights object corresponding to a content object to be executed, and deletes a rights object corresponding to the revocation notification when the author is an author having the revocation right. A controller controls the modules and the units.

### CROSS-REFERENCE TO RELATED APPLICATION(S) AND CLAIM OF PRIORITY

The present application claims priority to an application entitled “Rights Object Management Method, Content Object Revocation Method Based Thereon, and Device Using the Same” filed in the Korean Industrial Property Office on Jun. 26, 2008, and assigned Serial No. 10-2008-0060942, the contents of which are hereby incorporated by reference.

### TECHNICAL FIELD OF THE INVENTION

The present invention relates to a method and apparatus for Digital Rights Management (DRM), and more particularly to a rights object management method, a content object revocation method based on the rights object management method, and a device using the methods.

### BACKGROUND OF THE INVENTION

Digital rights management (DRM) is a technology for protecting the rights and profits of content providers by preventing contents from being copied and distributed illegally. DRM Secure Content Exchange (DRM SCE) supports a function of enabling a user device to create a content object (CO) and a rights object (RO), and to safely transmit data to another device through a Mutual Authentication and Key Exchange (MAKE) procedure.

FIG. 1 illustrates a view showing the concept of the general DRM, which includes a device 110 which desires access to content, e.g., encrypted content, protected by encryption or the like, a content issuer 120 for providing content, a rights issuer 130 which issues a RO including a license to execute content, and a certification authority 140 which issues certificates.

The device 110 can obtain desired content from the content issuer 120, wherein the content is encrypted. The device 110 can purchase an RO including a license to use the encrypted content from the Rights Issuer (RI) 130, and the device 110 having purchased the rights object can use the encrypted content.

The certification authority 140 issues a certificate including an identifier of a device whose public key is validated, a certificate serial number, the name of the certificate authority issuing the certificate, and a message indicating the public key of a corresponding device and the expiration date of the certificate written thereon. Whether or not such a certificate is valid is checked by making reference to an Online Certificate Status Protocol (OCSP) or a Certificate Revocation List (CRL). Each device can check whether another device communicating with the corresponding device is authorized through a certificate issued by the certification authority 140. Through such a procedure, each device can safely transfer important information to another device.

As described above, in order for the device 110 to receive a content object and an RO, and then to use the content object, the device 110 must necessarily have a rights object corresponding to the content object. Therefore, the device 110 compares the hash value of an actually received content object with the hash value of the content object stored within the rights object, thereby identifying whether or not the content object is valid.

### SUMMARY OF THE INVENTION

As described above, in order for a device to determine whether or not a content object is valid, the device includes a rights object corresponding to the content object. However, when an author having provided a rights object does not desire to distribute the corresponding content any more, or when the author desires to prohibit the use of the content on account of a problem in the content, or the like, currently is no way exists to prevent the content from being used because the rights object has already been provided. That is, since the rights object has already been paid and purchased by the user, it is impossible to prevent content from being executed through the use of the rights object.

To address the above-discussed deficiencies of the prior art, it is a primary object to provide a rights object management method for restricting the usage right of a rights object and the use of content in a device as the occasion arises, a content object revocation method based on the rights object management method, and a device using the methods.

In accordance with an aspect of the present invention, there is provided a method for managing a content object in a device, the method comprising: receiving an encrypted content from the other device; extracting a rights object from the encrypted content, the rights object having a authority to execute the content; storing the rights object and the encrypted content; when a revocation notification of the content is received from the other device, determining if the other device transferring the revocation notification is a device having a revocation right using the rights object; and when the other device is a device having the revocation right, deleting the rights object corresponding to the revocation notification.

In accordance with another aspect of the present invention, there is provided a method for revoking a content object in a digital right management system, the method comprising the steps of: receiving, by a device, a content object; requesting a server to check if the received content object is valid; receiving, by the device, a response message which includes a result of checking if the received content object is valid from the server; and determining whether to revoke the content object based on the response message.

In accordance with yet another aspect of the present invention, there is provided a device for managing a content object and revoking a content object, the device including: a content/rights object storage unit for storing at least one content object, and a rights object corresponding to each content object; an authentication module for performing mutual authentication between devices giving and taking a rights object, and when a revocation notification of a rights object among the stored rights object is received from the other device, authenticating whether the other device transferring the revocation notification is a device having a revocation right; a content object checking unit for checking if the content object is valid before the content object is executed; a rights object management module for searching for a rights object corresponding to a content object to be executed, and deleting a rights object corresponding to the revocation notification when the other device is a device having the revocation right; and a controller for controlling the modules and the units.

In accordance with another aspect of the present invention, there is provided a method for managing a content object in a device, the method comprising: receiving an encrypted content; receiving a rights object having a authority to execute the encrypted content; storing the rights object and the encrypted content; when a revocation notification of the content is received from the other device, determining if the other device transferring the revocation notification is a device having a revocation right using the rights object; and when the other device is a device having the revocation right, deleting the rights object corresponding to the revocation notification.

In accordance with another aspect of the present invention, there is provided a method for providing a rights object in a device, the method comprising: generating a rights object for executing a specific content, the right object includes information to execute content-related permission items and restriction items, control information for accessing to content and information of an author having an authority of revocation of the rights object; and storing the right object related to the specific content.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a view showing the concept of the general DRM;

FIG. 2 illustrates a block diagram of the configuration of a device according to an exemplary embodiment of the present invention;

FIG. 3 illustrates a view of the structure of a rights object according to an exemplary embodiment of the present invention;

FIG. 4 illustrates a flowchart for a rights object revocation procedure corresponding to a revocation notification according to an exemplary embodiment of the present invention; and

FIG. 5 illustrates a flow diagram for a method for checking if content is valid according to an exemplary embodiment of the present invention.

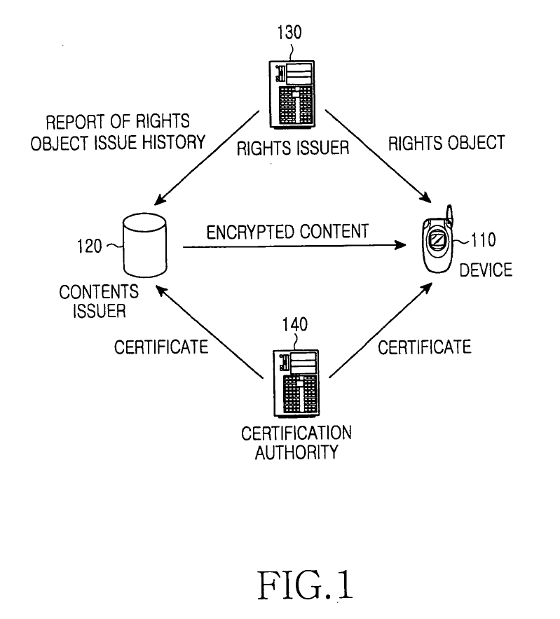

### DETAILED DESCRIPTION OF THE INVENTION

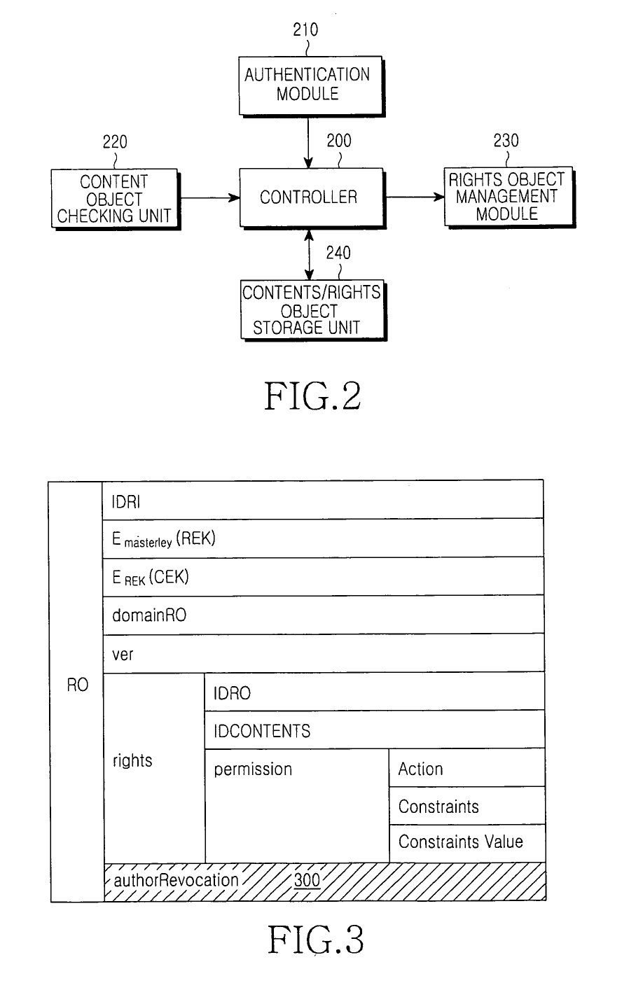

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications network.

FIG. 2 illustrates a block diagram of the configuration of a device according to an exemplary embodiment of the present invention. The device includes a controller 200, an authentication module 210, a content object checking unit 220, a rights object management module 230, and a contents/rights object storage unit

First, the authentication module 210 performs mutual authentication between devices that give and take rights objects. According to an embodiment of the present invention, when a rights object is received, the authentication module 210 performs authentication of the counterpart, e.g., a device or an author, which has transferred the rights object. When the mutual authentication fails, the authentication module 210 transmits a message indicating that the mutual authentication has failed to the counterpart that has transferred the rights object. In contrast, when the mutual authentication is successful, the authentication module 210 transmits a response message including an address to receive a rights object revocation notification in the future, together with a mark indicating that the authentication module 210 has received the rights object, to the counterpart. In addition, when a notification to revoke a rights object from among the rights objects stored in the content/rights object storage unit 240 is received, the authentication module 210 functions to authenticate whether a device or author that has transmitted the notification has the right of revocation. The authentication module 210 uses a public key that is obtained by exchanging with the device or author for authentication using a certificate.

The content object checking unit 220 is a means for using content objects stored in a device, and functions to check if a content object is valid before the content object is used. For example, since a content object to be used may contain abnormal content or may be infected with a virus, it is necessary to check the content object in advance. According to an embodiment of the present invention, the checking method includes a method of asking a server whether or not a content object to be used is normal online, and a method of directly checking if a content object is valid through the use of a list of abnormal content objects that are updated periodically. Accordingly, before the content object is executed, the content object checking unit 220 checks if the content object is valid by making reference to the list of abnormal content objects provided from a server, or the content object checking unit 220 requests a server to report whether or not the content object is valid and checks if the content object is valid based on a response to the request.

The rights object management module 230 searches for a rights object corresponding to the content object to be used. Then, the rights object management module 230 provides the searched rights object to the controller 200, which controls the execution of the content, or to the content object checking unit 220 using the content object. This enables the content to be executed using the searched rights object. According to an embodiment of the present invention, the rights object management module 230 functions to delete a rights object when receiving a notification to revoke the rights object.

The content/rights object storage unit 240 stores content objects, and rights objects corresponding to the respective content objects. For example, content is encrypted into DRM Content Format (DCF) according to a DRM system, and is then stored. Since the encrypted content cannot be used as it is, a Content Encryption Key (CEK) to decrypt the encrypted content is required, wherein the CEK is included in a corresponding rights object.

In addition, the content/rights object storage unit 240 may store a list of abnormal content objects. In order to prevent the execution of content having a problem and the execution of content infected with a virus, or a program to hack important information of a device, a list of abnormal content objects is made as content is verified to be inappropriate through a monitoring organization, or a report of a user who has used the content. Such a list may be transferred from a server to the device periodically or whenever the need arises, and is updated.

Meanwhile, the structure of a revocable rights object stored in the content/rights object storage unit 240 is illustrated in FIG. 3. An embodiment of the present invention proposes the structure of a rights object including the additional element “authorRevocation” 300, as shown in FIG. 3, in order to enable an already paid rights object to be revoked by an author, who provides the rights object.

The controller 200 takes charge of the general control of the device, and particularly functions to control the aforementioned components, and so forth, when it is required to restrict the use of a rights object and a content object according to an exemplary embodiment of the present invention.

Hereinafter, the structure of the rights object shown in FIG. 3 will be described in detail. The rights object includes information to execute content-related permission items and restriction items and to control access to contents. In particular, the rights object includes important information, containing an identifier, “IDRI”, of a rights object issuer, a Rights Encryption Key (REK), “E_{masterkey}”, that is an encrypted right key used to encrypt CEK, a CEK, “E_{REK}”, representing a symmetric key to decrypt an encrypted content, a domain rights object “domainRO”, a version “ver” of a DRM system, rights, and so forth.

Embodiments of the present invention propose the structure of a rights object to which element “authorRevocation” 300 is added. The element “authorRevocation” 300 includes an element expressing that the rights object can be revoked by an author, an element of the identifier of the author who creates the rights object, and an element representing the address through which the author can receive data from the device.

TABLE 1

| | |
|---|---|
| Element | <!ELEMENT authorRevocation> |
| Semantics | Element representing that author can revoke |
| Attribute | <!ATTLIST authorRevocation authorId |
| | CDATA #REQUIRED> |
| Semantics | Identifier of author having authorRevocation right> |
| Attribute | <!ATTLIST authorRevocation authorAdd |
| | CDATA #REQUIRED> |
| Semantics | Address of author device having authorRevocation right |

A device having received a rights object of such a structure revokes the rights object without delay when the device receives notification to revoke the rights object from an author having the right of revocation of the rights object in the future. To this end, the device determines if an author having transferred a revocation notification is a lawful author, based on the element representing that the author can revoke the rights object, shown in Table. 1. When a device receives a rights object, as shown in FIG. 3, the device transmits a response message including an address to receive notification of the revocation of the rights object, together with a mark indicating that the device has received the rights object. After this, the author, having the right of revocation of the rights object, can instruct the device to revoke the previously transferred rights object through the use of the response message at a desired time, regardless of time.

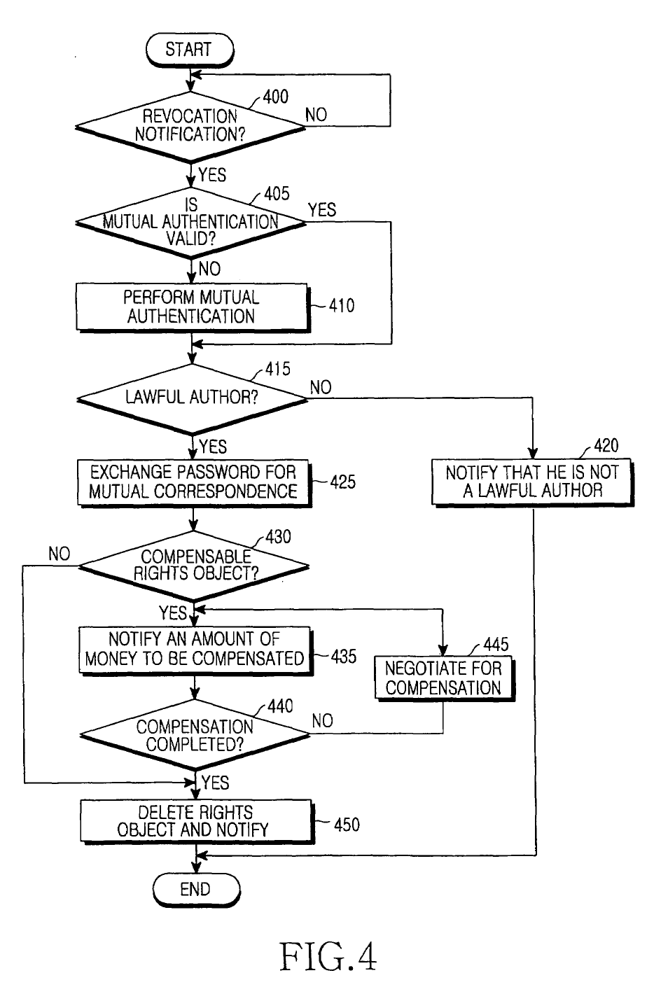

Hereinafter, a rights object revocation procedure corresponding to a revocation notification according to an exemplary embodiment of the present invention will be described with reference to FIG. 4. In the example illustrated in FIG. 4 a device has received a rights object, having such a structure as shown in FIG. 3, from a counterpart in advance.

In step 400, the device determines if the notification of the revocation of a rights object has been received. When it is determined that the revocation notification has been received as a result of the determination, it is determined if mutual authentication is valid in step 405. When mutual authentication is invalid, mutual authentication is performed through the use of a certificate in step 410. In contrast, when mutual authentication is in a valid state, the device determines if a counterpart, e.g., a device or an author, having transferred the revocation notification is a lawful author having the right of revocation in step 415. In particular, the device compares the identifier of an author included in the revocation-targeted rights object with the identifier of the counterpart requesting the revocation, and determines that the counterpart is a lawful author when the two identifiers coincide with each other.

When it is determined that the counterpart is not a lawful author in step 415, the devices proceeds to step 420, where the devices notify the counterpart that the counterpart is not a lawful author. Thereafter, the current operation is then terminated. Conversely, when the counterpart is determined to be a lawful author in step 415, the devices perform a password exchange for mutual correspondence in step 425. For example, the password exchange is performed to keep data security in a one-to-one correspondence with the counterpart, who has transferred the revocation notification. Thereafter, it is determined if the rights object revocation-targeted according to the revocation notification is a compensable rights object in step 430. This is based on when the use of a paid rights object is to be prohibited.

When the rights object is a compensable rights object in step 430, the device notifies the counterpart requesting the revocation of the amount of compensation money in step 435. It is determined if the compensation has been completed in step 440, a negotiation for compensation, such as re-adjustment of the amount of compensation money, is again performed in step 445 when the compensation has not been completed. When the compensation has been completed, in step 440, through such a procedure, the device proceeds to step 450, where the device deletes the corresponding rights object, and notifies the counterpart that the rights object has been deleted.

As described above, according to the present invention although a rights object has already been paid and purchased by the user, it is possible to directly instruct a device to revoke the rights object for the purpose of preventing the rights object from being used, so that there is an advantage in that the author providing the rights object can prevent the rights object from being used at the time the author does not desire to distribute the corresponding contents any more.

Meanwhile, when it is desired to prevent content from being used because of a problem in the content, or the like, it is possible to use the method of revoking a rights object required for executing the content, as described above, or it is possible to use a method of reporting information on abnormal content so as to prevent the abnormal content from being executed.

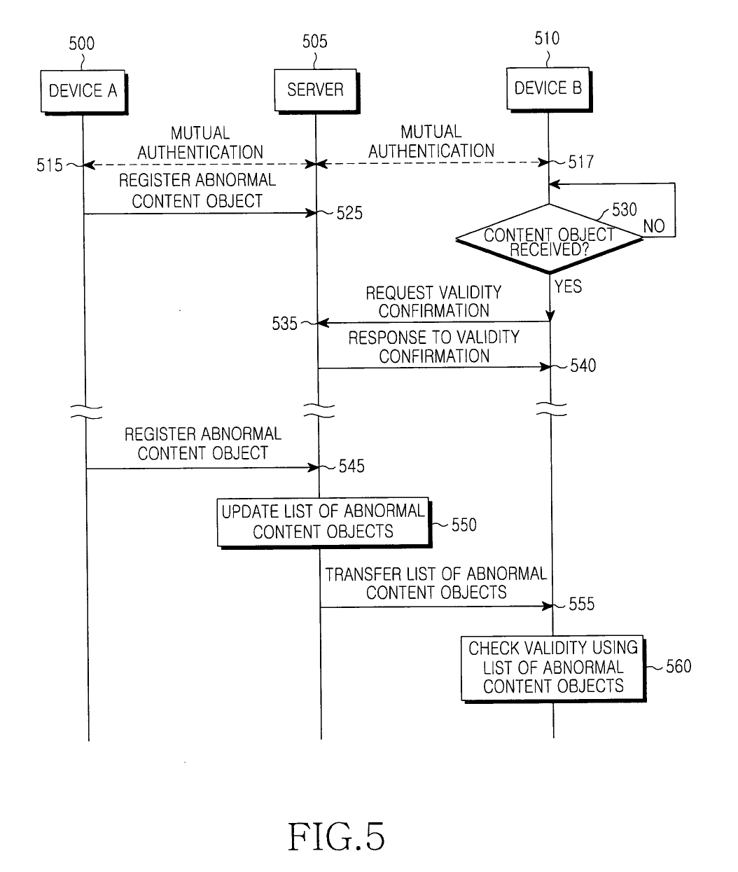

Hereinafter, a method for preventing abnormal content and content received from an unwanted party from being executed in a device will be described with reference to FIG. 5. The flow diagram of FIG. 5 illustrates a method that a device, having received a content object in the online scheme, directly asks a server if the content object is valid, and a method of receiving a list of abnormal content objects in the offline scheme and checking if each content object is valid based on the received list.

Device A 500 performs mutual authentication with the server 505 in step 515, and device B 510 performs mutual authentication with the server 505 in step 517. The procedure of performing the mutual authentications is based on a mutual authentication scheme used between a server and a device in a general DRM system, so a detailed description thereof will be omitted. When the mutual authentications have been completed, device A 500 and device B 510 can safely give and take data with the server 505. In the illustrated example, device A 500 is a device of the user who desires to prevent content from being used, and device B 510 is a device of the user who desires to check if content is valid.

When device A 500 receives a content object, tries to use the content object, and finds it impossible to execute the content object because the content object is an abnormal content object, or when device A 500 finds the content object infected with a virus, device A 500 can register the abnormal content object with the server 505 in step 525. It will be understood that content having a problem may be registered as an abnormal content object with the server 505 by the user's report, as in step 525, and also the server 505 may be provided with information on content objects that are determined to be inappropriate from a monitoring organization. Through this, the server 505 can manage information on abnormal content objects.

After that, when device B 510 receives the same content object as that received by device A 500 in step 530, device B 510 can directly ask the server 505 if the content object is abnormal before executing the received content object. Therefore, device B 510 transfers a validity verification request to the server 505 in step 535, and receives a validity verification response corresponding to the request in step 540. Device B 510 verifies whether the content object is valid, and stores the content object if the content object has a problem. Conversely, if the content object has a problem, device B 510 revokes the content object, notifies a counterpart, e.g., a device or a content provider, providing the content object that the content object has a problem, and requests the counterpart to provide a normal content object at the same time.

Steps 525 to 540 relate to a method where a device, having received a content object in the online scheme, directly asks a server if the content object is valid. Additionally, steps 545 to 560, to be described hereinafter, relate to a method of receiving a list of abnormal content objects in the offline scheme and checking if each content object is valid based on the received list.

Device A 500 registers an abnormal content object in step 545. Accordingly, the server 505 updates a Content Problem List (CPL), which is a list of abnormal content objects and is stored in the server 505, in step 550. The user may update the list of abnormal content objects stored in the server 505, even for the processing of a content object received from an undesired counterpart. Differently from certificate revocation lists, the CPL used in the present invention utilizes a content URL header and content-location header information, included in a DCF header, in order to manage abnormal content objects.

Although FIG. 5 illustrates a case where one device, i.e., device A 500, provides information on a content object having a problem to the server 505, it will be understood that a plurality of devices may provide such information. Accordingly, the server 505 manages such information as a list, updates the list, and transfers the list to device B 510 periodically or whenever the need arises in step 555. Therefore, when the device B 510 receives a new content object, the device B 510 checks if the received content object is valid through the use of the list of abnormal content objects, as shown in step 560. That is, the device B 510 determines if the received content object is included in the list of abnormal content objects. Through this, the provider of content can prevent the content from being distributed and can revoke the content. Additionally, it is possible to prevent abnormal content and content received from an unwanted party from being executed in a device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for managing a content object in a device, the method comprising:
receiving an encrypted content from the other device;
extracting a rights object from the encrypted content, the rights object having a authority to execute the content;
storing the rights object and the encrypted content;
when a revocation notification of the content is received from the other device, determining if the other device transferring the revocation notification is a device having a revocation right using the rights object; and
when the other device is a device having the revocation right, deleting the rights object corresponding to the revocation notification.

2. The method as set forth in claim 1, wherein the rights object comprises information for identifying an author generating the rights object.

3. The method as set forth in claim 1, further comprising: transmitting a response message for the stored rights object to the other device, which includes information on an address to receive the revocation notification.

4. The method as set forth in claim 1, wherein the other device is a content issuer.

5. The method as set forth in claim 1, wherein the determining comprising:
performing mutual authentication with the other device;
determining if the other device transferring the revocation notification is a device having a revocation right when the mutual authentication is valid.

6. The method as set forth in claim 1, wherein the rights object comprises at least one of:
information representing that the rights object is a revocable rights object;
information for identifying the author having the right of the revocation notification; and
information on an address of the author.

7. The method as set forth in claim 1, wherein deleting the rights object comprises:
exchanging a password for data security with the other device transferring the revocation notification;
determining if the rights object corresponding to the revocation notification is a compensable rights object;
when the rights object corresponding to the revocation notification is a compensable rights object, notifying the other device transferring the revocation notification of an amount of money to be compensated; and
when the compensation is completed, deleting the rights object.

8. A method for revoking a content object in a digital right management system, the method comprising the steps of:
receiving, by a device, a content object;
requesting a server to check if the received content object is valid;
receiving, by the device, a response message which includes a result of checking if the received content object is valid from the server; and
determining whether to revoke the content object based on the response message.

9. The method as set forth in claim 8, further comprising:
receiving an updated list from the server when a list of abnormal content objects is updated using information on the registered abnormal content object in the server.

10. The method as set forth in claim 9, further comprising checking, by the device receiving the content object, if the received content object is valid by making reference to the provided updated list.

11. A method for managing a content object in a device, the method comprising:
receiving an encrypted content;
receiving a rights object having a authority to execute the encrypted content;
storing the rights object and the encrypted content;
when a revocation notification of the content is received from the other device, determining if the other device transferring the revocation notification is a device having a revocation right using the rights object; and
when the other device is a device having the revocation right, deleting the rights object corresponding to the revocation notification.

12. The method as set forth in claim 11, wherein the encrypted content is received from a content issuer and the rights object is received from a rights issuer.

13. The method as set forth in claim 11, wherein the rights object comprises information for identifying an author generating the rights object.

14. The method as set forth in claim 11, further comprising: transmitting a response message for the stored rights object to the other device, which includes information on an address to receive the revocation notification.

15. The method as set forth in claim 11, wherein the determining comprising:
performing mutual authentication with the other device; determining if the other device transferring the revocation notification is a device having a revocation right when the mutual authentication is valid.

16. A device for managing a content object and revoking a content object, the device comprising:
a content/rights object storage unit for storing at least one content object, and a rights object corresponding to each content object;
an authentication module for performing mutual authentication between devices giving and taking a rights object, and when a revocation notification of a rights object among the stored rights object is received from the other device, authenticating whether the other device transferring the revocation notification is a device having a revocation right;
a content object checking unit for checking if the content object is valid before the content object is executed;
a rights object management module for searching for a rights object corresponding to a content object to be executed, and deleting a rights object corresponding to the revocation notification when the other device is a device having the revocation right; and
a controller for controlling the modules and the units.

17. The device as set forth in claim 16, wherein the rights object comprises information representing that the rights object is a revocable rights object, information for identifying the author having the right of the revocation notification, and information on an address of the author.

18. The device as set forth in claim 12, wherein the authentication module determines if the other device is a device having the revocation right by making reference to information for identifying an author having a right of the revocation notification.

19. The device as set forth in claim 12, wherein, when a rights object is received, the authentication module transmits a response message, which includes information representing that the rights object has been received and information on an address to receive the revocation notification, to a device transmitting the rights object.

20. The device as set forth in claim 16, wherein, before the content object is executed, the content object checking unit checks if the content object is valid by making reference to a list of abnormal content objects.

21. The device as set forth in claim 16, wherein, before the content object is executed, the content object checking unit requests a server to check if the content object is valid, and checks if the content object is valid based on a response received according to the request.

22. A method for providing a rights object in a device, the method comprising:
generating a rights object for executing a specific content, the right object includes information to execute content-related permission items and restriction items, control information for accessing to content and information of an author having an authority of revocation of the rights object; and
storing the right object related to the specific content.

23. The method as set forth in claim 22, wherein the device is a right issuer.

24. The method as set forth in claim 22, wherein the rights object comprises at least two of:
an identifier of a rights object issuer, a Rights Encryption Key (REK) that is an encrypted right key used to encrypt CEK, a CEK (Content Encryption Key) representing a symmetric key to decrypt an encrypted content, a domain rights object, a version of a DRM system and the information of an author having an authority of revocation of the rights object.

25. The method as set forth in claim 24, wherein the information of an author having an authority of revocation of the rights object comprises at least one of:
information for identifying an author generating the rights object; and information on an address to receive data from a device.
